(19) United States
(12) Patent Application Publication
(10) Pub. No.: US 2024/0068193 A1
(43) Pub. Date: Feb. 29, 2024

(54) DAMPING RATIO MEASURING DEVICE AND SIGNAL PROCESSING METHOD SUITABLE FOR CONSOLIDATION EQUIPMENT

(71) Applicant: Chang’an University, Xi'an (CN)

(72) Inventors: Hengxing LAN, Xi'an (CN); Kuijian DU, Xi'an (CN); Langping LI, Xi'an (CN); Xin LIU, Xi'an (CN); Ning ZHANG, Xi'an (CN); Yuming WU, Xi'an (CN)

(73) Assignee: Chang’an University, Xi'an (CN)

(21) Appl. No.: 18/271,922

(22) PCT Filed: Apr. 14, 2022
(86) PCT No.: PCT/CN2022/086759

§ 371 Date: Jul. 12, 2023

(30) Foreign Application Priority Data
Apr. 29, 2021 (CN) 202110477763.5

(51) Int. Cl. E02D 1/02; E02D 3/046

(52) U.S. Cl. CPC E02D 1/022; E02D 3/046; G01N 3/08

(57) ABSTRACT

A damping ratio measuring device for consolidation equipment includes a bracket, a consolidation pressure device and a sleeve. The consolidation pressure device is set at the top of the bracket, and the output direction of the consolidation pressure device is directly below. The bottom of the consolidation pressure device is connected with a pressurized piston. A displacement sensor is set on the pressurized piston. The sleeve is set directly below the consolidation pressure device, the pressurized piston extends from the top of the sleeve, the diameter of the pressurized piston is the same as the inner diameter of the sleeve, the bottom of the sleeve is sealed with a support plate, and there are two bending element sensors at the top of the support plate and the bottom of the pressurized piston.

### CROSS REFERENCE TO THE RELATED APPLICATIONS

This application is the national phase entry of International Application No. PCT/CN2022/086759, filed on Apr. 14, 2022, which is based upon and claims priority to Chinese Patent Application No. 202110477763.5, filed on Apr. 29, 2021, the entire contents of which are incorporated herein by reference.

### TECHNICAL FIELD

The present invention belongs to the field of geotechnical engineering detection, and relates to a damping ratio measuring device and a signal processing method suitable for consolidation equipment.

### BACKGROUND ART

Damping ratio is the basic parameter of dynamic analysis in geotechnical engineering, the loss of signal energy may come from the energy dissipation of the intrinsic attenuation of the soil itself, for example, the friction loss between soil particles, etc. In geotechnical engineering research, this energy loss is usually quantified by damping ratio D. However, the uncertainty and inaccuracy of measurement results often exist in the measurement of damping ratio in consolidation test, especially in the case of little strain. For example, under the condition of little strain (<10⁻⁵), the measured damping ratio of fine sand is 0.20%-5.00%, the reason for appearance of the obvious deviation is that the damping ratio is actually a very small amount, any test deviation can easily affect the measured value. In this situation, it is a challenge to maintain the accuracy of damping ratio measurement during soil consolidation.

Material damping is a main form of damping, meanwhile it is also one of the basic properties of materials. Its measurement accuracy has important research and application value. In the soil damping test, due to the change of the test environment, as well as the damping characteristics of the measured soil itself and other factors, it causes various measurement deviations such as unstable damping test results and poor accuracy. At present in the damping test, the most commonly used method is the traditional damping test method, which calculates the damping characteristics by measuring the resonant vibration response curve of the measured object. The traditional test method has the advantages of clear and intuitive test principle and simple and clear operation steps, but there are two obvious defects in the measurement process of the traditional method. (1) The bending element is used as a sensor for damping measurement, in which the receiver element is only used as a signal receiving device. The received signal is easily disturbed by noise signal. These signals are often captured by the receiving signal source along with the main signal, thus affecting the measurement of damping ratio. Therefore, the received signal is often affected by the characteristics of the inherent components, leading to a bigger error of the test results when the test environment changes slightly in the process of testing damping. (2) Due to the close distance between the signal transmitting source and the signal receiving source, there will be obvious near-field effect in the signal transmission process, which will affect the accuracy of the received signal and the correctness of the test results, it can be found that the measurement error is the key factor to determine the accuracy of the measurement data. However, due to uncontrollable factors such as test equipment and test sites, test errors are inevitable. Therefore, without affecting the accuracy of the test, reducing the measurement error as much as possible has become a key issue in the measurement of soil damping ratio.

### SUMMARY

The purpose of the present invention is to overcome the shortcomings of the above existing technologies and provide a damping ratio measuring device and signal processing method suitable for consolidation equipment, which can change the inherent arrangement of signal transmitting and receiving finite element sensors, reduce the measurement error of damping ratio, and ensure the accuracy and reliability of damping ratio measurement of soil materials.

In order to achieve the above purpose, the present invention adopts the following technical scheme to realize:
a damping ratio measuring device suitable for consolidation equipment, including a bracket, a consolidation pressure device and a sleeve;
setting the consolidation pressure device at the top of the bracket, and the output direction of the consolidation pressure device is directly below, connecting the bottom of the consolidation pressure device with a pressurized piston, and setting a displacement sensor on the pressurized piston; setting the sleeve directly below the consolidation pressure device, the pressurized piston extends from the top of the sleeve, the diameter of the pressurized piston is the same as the inner diameter of the sleeve, the bottom of the sleeve is sealed with a support plate, there are two bending element sensors at the top of the support plate and the bottom of the pressurized piston.

Preferably, installing a pressure sensor on both sides of the sleeve and at the bottom of the support plate, the pressure sensor at the bottom of the support plate is located at the center of the support plate.

Preferably, setting the bending element sensor near the axis of the sleeve.

Preferably, using an O-ring to link sleeve and support plate.

Preferably, there are two support blocks at the bottom of the support plate, the support block and the support plate are eccentrically set.

Preferably, a displacement sensors adopts an LVDT displacement sensor, connecting the bottom of the consolidation pressure device to the top of the LVDT displacement sensor, the bottom of LVDT displacement sensor is connected to the top of the pressurized piston.

Preferably, the bracket includes a roof, a floor and a connecting rod, the connecting rod connects the roof and floor in parallel, setting the consolidation pressure device and sleeve between the roof and the floor.

Further, setting a latex film between the connecting rod and the floor.

Further, the connecting rod adopts screw, which is connected with the roof thread.

A damping ratio signal processing method suitable for consolidation equipment based on the above-mentioned device, using frequency spectrum ratio method to measure material damping ratio:

$$ln [ \frac{{U}_{1} ( f )}{{U}_{2} ( f )} ] - ln [ {( \frac{{r}_{1}}{{r}_{2}} )}^{β} T ] + \frac{2 π D}{V} ( {r}_{2} - {r}_{1} ) f \qquad ( 1 )$$

Wherein, U(f) is the amplitude of the signal at the displacement r, D is the damping ratio, β is a geometrical spreading constant, T is transmission coefficient, V is wave velocity, f is frequency;
the amplitude U(f) of the propagating wave is represented by the output voltage generated by the receiving bending element Y(f);

Y(f)=H_{R}(f)U(f) (2)
H_{R}(f) is bender element sensor transfer function;
carrying out positive and negative two signal transmission processes, and offsetting of the transfer function;
when forward transfer occurs:

$${H}_{R 2}^{- 1} ( f ) {Y}_{2 a} ( f ) = {H}_{R 1}^{- 1} ( f ) {Y}_{1 a} ( f ) {( \frac{{r}_{1}}{{r}_{2}} )}^{β} \times exp [ - \frac{2 π D}{V} ( {r}_{2} - {r}_{1} ) f ] {T}_{a} \qquad ( 3 )$$

when reverse transfer occurs:

$${H}_{R 1}^{- 1} ( f ) {Y}_{1 b} ( f ) = {H}_{R 2}^{- 1} ( f ) {Y}_{2 b} ( f ) {( \frac{{r}_{1}}{{r}_{2}} )}^{β} \times exp [ - \frac{2 π D}{V} ( {r}_{2} - {r}_{1} ) f ] {T}_{b} \qquad ( 4 )$$

Substituting formula (2) (3) (4) into formula (1), the transfer function of formula (3) and (4) set off against each other to obtain the result:

$$ln [ \frac{{Y}_{1 a} ( f ) {Y}_{2 b} ( f )}{{Y}_{2 a} ( f ) {Y}_{1 b} ( f )} ] = - ln [ {( \frac{{r}_{1}}{{r}_{2}} )}^{2 β} {T}_{a} {T}_{b} ] + \frac{4 π D}{V} ( {r}_{2} - {r}_{1} ) f$$

Wherein, Tₐ and T_{b} are transmission coefficient of two conduction waves. Y is output voltage of bending element sensor.

Compared with the existing technology, the present invention has the following beneficial effects:

The present invention has two signal sensors arranged at the bottom and top of the consolidation instrument respectively. The sensor at the bottom is used as the signal transmitting source and receiving source, and the top sensor is used as the signal receiving and transferring device, which solves the near-field effect generated when the signal is received. Two bottom sensors are used as signal emission sources respectively to carry out positive and negative two signal transmission processes, in the process of signal processing, forward and reverse signals are processed for offset, eliminating disturbance signals, which realizes the accuracy of damping ratio measurement during reconsolidation.

Further, placing the bending element sensor in the middle of the consolidation instrument roof to minimize the influence of interference signals from the boundary and periphery of the consolidation instrument.

Further, the two sensor brackets arranged on the same side are not connected to each other, two latex films are placed under each bracket to cut off all signal interference from the connecting frame and the bottom of the container.

### BRIEF DESCRIPTION OF THE DRAWINGS

FIG. 1 is the structure diagram of the present invention;

FIG. 2 is a schematic diagram of the positive and negative signal transmission processes of the present invention.

Wherein, 1—roof; 2—screw; 3—floor; 4—LVDT displacement sensor; 5—consolidation pressure device; 6—set bolt; 7—pressurized piston; 8—vertical rod; 9—fixed disk; 10—sleeve; 11—connecting rod; 12—support block; 13—pressure sensor; 14—bending element sensor; 15—O ring; 16—insulator bracket; 17—support plate.

### DETAILED DESCRIPTION OF THE EMBODIMENTS

The following is a further detailed description of the invention in combination with the drawings.

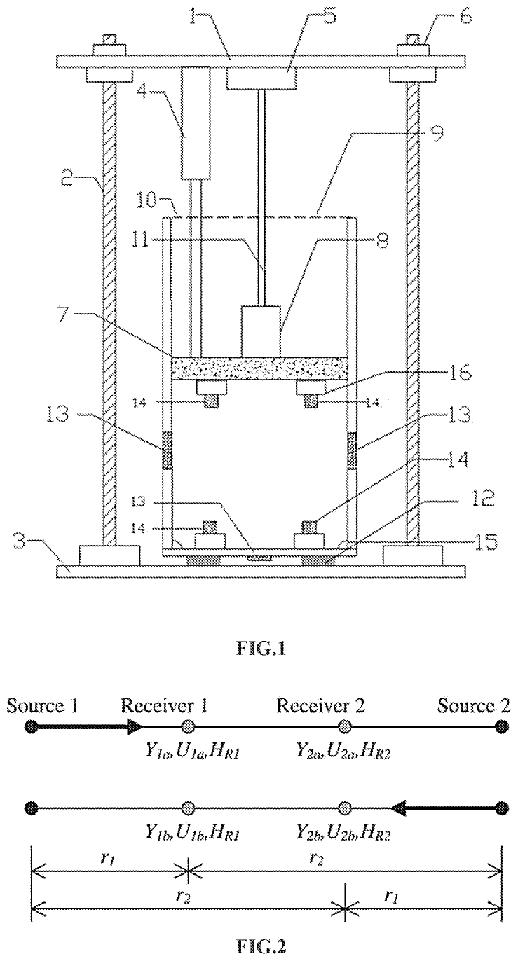

As shown in FIG. 1, the damping ratio measuring device for consolidation equipment described in the present invention includes a bracket, a consolidation pressure device 5 and a sleeve 10.

The bracket comprises a roof 1, a connecting rod and a floor 3, set in sequence from top to bottom, roof 1 and floor 3 are parallel to the horizontal plane and fixed by connecting rod, sleeve 10 is set between the top plate 1 and the bottom plate 3; the roof 1 and the floor 3 are fixed by means of set bolts 6 to the connecting rods on both sides, the preferred connecting rod of this implementation example adopts screw 2.

A consolidation pressure device 5 is fixed at the bottom of roof 1 for applying normal pressure, the consolidation pressure device 5 is connected with the vertical rod 8 and the pressurized piston 7 through the connecting rod 11, the diameter of the pressurized piston 7 is the same as the inner diameter of the sleeve 10.

The free end of LVDT displacement sensor 4 armature iron is fixed to the top of pressurized piston 7, the range of LVDT displacement sensor 4 is the same as the maximum depth of sleeve 10.

There are two support blocks 12 on the floor 3, the top surface is provided with a support plate 17, the inner diameter of support plate 17 is the same as that of sleeve 10, the bottom of the sleeve 10 is sleeved outside the support block 12, the bottom of sleeve 10 is suspended, when the soil sample is placed inside the sleeve 10, the pressurized piston 7 is above the soil sample, and the piston diameter is the same as the inner diameter of the sleeve 10.

There are threaded holes on both sides of roof 1, and screw holes at the corresponding position of floor 3, two vertical screws 2 pass through the hole respectively, and the bottom plate 3 and the top plate 1 are fixedly connected by the fastening nut; roof 1 and floor 3 are made of 2-3 cm thick steel plate, ensuring the strength and stiffness required for the test; the screw 2 with thread is made of steel screw, and its length should be left surplus, so as to adjust the spacing between the top plate 1 and the bottom plate 3.

Sleeve 10 is surrounded by a steel plate with a thickness of 3 cm to provide sufficient vertical support to prevent radial deformation during consolidation; the cylindrical sleeve 10 is not fixed with the top plate 1, the bottom of the sleeve 10 is fixed with two detachable support blocks 12, the inner wall of the sleeve 10 is as smooth as possible to reduce the generation of greater sidewall friction.

U-shaped grooves are arranged at the bottom of the sleeve 10 and the top of the floor 3 to place the O-ring 15, so that the consolidation area of the soil sample is in a sealed state to prevent the soil sample from squeezing out during the consolidation process.

The bottom of the roof 1 is fixed with a displacement sensor, which is located directly above the pressurized piston 7, the induction head faces the pressurized piston. In this example, LVDT displacement sensor 4 is preferred. The free end of LVDT displacement sensor 4 is fixed with the pressurized piston 7 to measure the consolidation settlement deformation of soil samples.

Three pressure sensors are installed on the left and right sides of the sleeve 10 and the bottom of the support plate 17, it is specifically installed on the outer wall or embedded in the side wall to collect the pressure change of the inner wall of the sleeve 10 during the consolidation test.

Two bending element sensors 14 are arranged at the top of the supporting plate 17 and the bottom of the pressurized piston 7, respectively, for transmitting and receiving signal waves and measuring the damping characteristics of the test material, the bending element sensor 14 is connected to the device through the insulation bracket 16, in order to isolate external signal interference.

When using this device to consolidate soil samples and measure damping, first, the roof 1, floor 3 and two screws are connected and assembled into a support frame, and the LVDT displacement sensor 4 is fixed with bolts on the top plate 1, fixing the bracket 12 on the floor 3, placing the sleeve 10 on the bracket 12, placing the O-ring 15 inside the sleeve 10, and fixing two isolation brackets 16 on the bottom plate of sleeve 10 and the bottom plate of pressurized piston 7, the isolation bracket is separated from the sleeve wall by 3 cm, the bending element sensor 14 is fixed on the isolation bracket 16 to connect the pressure sensor 13 to the signal collector with the computer, opening the data acquisition software, setting the pressure parameters, and preparing for data acquisition. Then starting sample preparation, placing soil samples in three layers, compaction in layers. After the sample preparation is completed, the top of the soil sample is placed from the bottom up in turn on the permeable stone plate, O-ring 15, piston 7 and consolidation pressure device 5, the free end of the armature of LVDT displacement sensor 4 is fixed to the top of the pressurized piston 7, the bending element sensor 14 is connected with the sine pulse transmitter and the signal receiver respectively to generate the electrical signal. In the process of consolidation and settlement, the floating pressurized piston 7 moves accordingly, which greatly reduces the relative displacement between the soil sample and the sleeve 10 and reduces the side wall friction resistance of the soil sample.

Peripheral electronic equipment, pulse signal is emitted by a single sine pulse emitter, amplified by a power amplifier, the received signal is enhanced by a filter and an amplifier. All signals are recorded by an oscilloscope at the same sampling frequency to ensure the stability of signal transmission throughout the test process.

The present invention also discloses the signal processing method in the damping ratio measurement test, and uses the spectrum ratio method to measure the soil damping ratio. In the process of signal conduction, due to the different initial strength of the signal, the damping characteristics of the material itself are also different. When the initial amplitude is small, the damping is usually linear, and the damping ratio D is usually determined by the frequency of the signal wave, which is independent of the displacement. When the amplitude is in the middle and high section, the damping gradually becomes nonlinear. The related damping ratio D is usually independent of frequency, and is related to the conduction displacement and friction. Based on the above three factors that cause signal conduction attenuation, the amplitude attenuation function is summarized:

$$\frac{{U}_{2} ( f )}{{U}_{1} ( f )} = {( \frac{{r}_{1}}{{r}_{2}} )}^{β} exp [ - α ( {r}_{2} - {r}_{1} ) T$$

Wherein, U(f) is the amplitude of the signal at the displacement r; β is a geometric diffusion constant. The signal wave propagates 0 in plane, 1.0 in sphere and 0.5 in cylinder. T is the transmission coefficient; a denotes the attenuation coefficient related to damping ratio D;

$$α = \frac{2 π}{λ} D = \frac{2 π f}{V} D \qquad ( 2 )$$

wherein, λ is the wavelength; v is wave velocity; f is frequency.

Substituting the formula into the formula, taking natural logarithms on both sides at the same time, and sorting out each item separately;

$$ln [ \frac{{U}_{1} ( f )}{{U}_{2} ( f )} ] - ln [ {( \frac{{r}_{1}}{{r}_{2}} )}^{β} T ] + \frac{2 π D}{V} ( {r}_{2} - {r}_{1} ) f$$

The damping ratio D can be simply obtained from the slope of the ratio diagram of the spectral ratio In [U1(f)/U2(f)] to the frequency f. This is the measurement of material damping ratio by spectral ratio method.

On this basis, the present invention further optimizes the above signal processing method by rearranging the damping sensor of the consolidation instrument. The above signal processing method is based on the assumption that the signal processing process received by the two signal receiving sensors is exactly the same, however, even if the two sensors of the same type, the signal processing process is not exactly the same, which will cause inherent deviation in the measurement of damping ratio, further optimization is carried out based on it.

In the bending element test, the amplitude U(f) of the propagating wave is represented by the output voltage generated by the receiving bending element Y(f). By customizing the introduction of the bending element sensor 14 transfer function HR(f), these two parameters can be interrelated:

Y(f)=H_{R}(f)U(f)

Because different sensors receive different signal processing processes, the transfer function HR(f) is different, therefore, the present invention here carries out two positive and negative signal transmission processes as shown in FIG. 2, and cancels the conduction function.
when forward transfer occurs:

$${H}_{R 2}^{- 1} ( f ) {Y}_{2 a} ( f ) = {H}_{R 1}^{- 1} ( f ) {Y}_{1 a} ( f ) {( \frac{{r}_{1}}{{r}_{2}} )}^{β} \times exp [ - \frac{2 π D}{V} ( {r}_{2} - {r}_{1} ) f ] {T}_{a}$$

when reverse transfer occurs:

$${H}_{R 1}^{- 1} ( f ) {Y}_{1 b} ( f ) = {H}_{R 2}^{- 1} ( f ) {Y}_{2 b} ( f ) {( \frac{{r}_{1}}{{r}_{2}} )}^{β} \times exp [ - \frac{2 π D}{V} ( {r}_{2} - {r}_{1} ) f ] {T}_{b}$$

After substituting the formula, the conduction function offsets each other to obtain the result:

$$ln [ \frac{{Y}_{1 a} ( f ) {Y}_{2 b} ( f )}{{Y}_{2 a} ( f ) {Y}_{1 b} ( f )} ] = - ln [ {( \frac{{r}_{1}}{{r}_{2}} )}^{2 β} {T}_{a} {T}_{b} ] + \frac{4 π D}{V} ( {r}_{2} - {r}_{1} ) f$$

Wherein, Tₐ and T_{b} are transmission coefficient of two conduction waves. Y is output voltage of bending element sensor. Through the optimization process, the damping ratio D is still obtained from the above spectral ratio and the slope of the frequency diagram, rather than the frequency-dependent transfer function, that is, it is not affected by the inherent difference of the sensor. At the same time, this method can also eliminate the influence of noise generated by peripheral electronic equipment.

The above content only explains the technical idea of the invention, and cannot limit the scope of protection of the invention. Any change made on the basis of the technical scheme according to the technical idea of the invention falls within the scope of protection of the claim of the present invention.

What is claimed is:

1. A damping ratio measuring device for consolidation equipment, comprising a bracket, a consolidation pressure device and a sleeve; wherein
the consolidation pressure device is set at a top of the bracket, and an output direction of the consolidation pressure device is directly below;
a bottom of the consolidation pressure device is connected with a pressurized piston, and a displacement sensor is set on the pressurized piston;
the sleeve is set directly below the consolidation pressure device;
the pressurized piston extends from the top of the sleeve, and a diameter of the pressurized piston is the same as an inner diameter of the sleeve; and
a bottom of the sleeve is sealed with a support plate, and there are two bending element sensors at a top of the support plate and a bottom of the pressurized piston.

2. The damping ratio measuring device according to claim 1, wherein a pressure sensor is installed on both sides of the sleeve and at a bottom of the support plate, and the pressure sensor at the bottom of the support plate is located at a center of the support plate.

3. The damping ratio measuring device according to claim 1, wherein the two bending element sensors are set near an axis of the sleeve.

4. The damping ratio measuring device according to claim 1, wherein an O-ring is used to link the sleeve and the support plate.

5. The damping ratio measuring device according to claim 1, wherein there are two support blocks at a bottom of the support plate, and the two support blocks and the support plate are eccentrically set.

6. The damping ratio measuring device according to claim 1, wherein the displacement sensor is an LVDT displacement sensor, the bottom of the consolidation pressure device is connected to a top of the LVDT displacement sensor, and a bottom of the LVDT displacement sensor is connected to the top of the pressurized piston.

7. The damping ratio measuring device according to claim 1, wherein the bracket includes a roof, a floor and a connecting rod, the connecting rod connects the roof and the floor in parallel, and the consolidation pressure device and the sleeve are set between the roof and the floor.

8. The damping ratio measuring device according to claim 7, wherein a latex film is set between the connecting rod and the floor.

9. The damping ratio measuring device according to claim 7, wherein the connecting rod is a screw connected with the roof by threads.

10. A damping ratio signal processing method for consolidation equipment based on the damping ratio measuring device according to claim 1, comprising;
measuring a material damping ratio by a spectral ratio method:
$$ln [ \frac{{U}_{1} ( f )}{{U}_{2} ( f )} ] - ln [ {( \frac{{r}_{1}}{{r}_{2}} )}^{β} T ] + \frac{2 π D}{V} ( {r}_{2} - {r}_{1} ) f \qquad ( 1 )$$
wherein, U(f) is an amplitude of a signal at a displacement r, D is a damping ratio, β is a geometrical spreading constant, T is a transmission coefficient, V is a wave velocity, f is a frequency;
an amplitude U(f) of a propagating wave is represented by an output voltage generated by a receiving bending element Y(f):
Y(f)=H_{R}(f)U(f) (2)
wherein H_{R}(f) is a bender element sensor transfer function;
carrying out two signal transmission processes, and offsetting a transfer function; wherein the two signal transmission processes comprises a forward transfer and a reverse transfer,
when the forward transfer occurs
$${H}_{R 2}^{- 1} ( f ) {Y}_{2 a} ( f ) = {H}_{R 1}^{- 1} ( f ) {Y}_{1 a} ( f ) {( \frac{{r}_{1}}{{r}_{2}} )}^{β} \times exp [ - \frac{2 π D}{V} ( {r}_{2} - {r}_{1} ) f ] {T}_{a} \qquad ( 3 )$$
when the reverse transfer occurs:
$${H}_{R 1}^{- 1} ( f ) {Y}_{1 b} ( f ) = {H}_{R 2}^{- 1} ( f ) {Y}_{2 b} ( f ) {( \frac{{r}_{1}}{{r}_{2}} )}^{β} \times exp [ - \frac{2 π D}{V} ( {r}_{2} - {r}_{1} ) f ] {T}_{b} \qquad ( 4 )$$
substituting formulas (2) (3) (4) into formula (1), wherein the transfer function of formulas (3) and (4) set off against each other to obtain a result:
$$ln [ \frac{{Y}_{1 a} ( f ) {Y}_{2 b} ( f )}{{Y}_{2 a} ( f ) {Y}_{1 b} ( f )} ] = - ln [ {( \frac{{r}_{1}}{{r}_{2}} )}^{2 β} {T}_{a} {T}_{b} ] + \frac{4 π D}{V} ( {r}_{2} - {r}_{1} ) f$$
wherein, Tₐ and T_{b} are transmission coefficients of two conduction waves, is an output voltage of the two bending element sensors.

11. The damping ratio signal processing method according to claim 10, wherein a pressure sensor is installed on both sides of the sleeve and at a bottom of the support plate, and the pressure sensor at the bottom of the support plate is located at a center of the support plate.

12. The damping ratio signal processing method according to claim 10, wherein the two bending element sensors are set near an axis of the sleeve.

13. The damping ratio signal processing method according to claim 10, wherein an O-ring is used to link the sleeve and the support plate.

14. The damping ratio signal processing method according to claim 10, wherein there are two support blocks at a bottom of the support plate, and the two support blocks and the support plate are eccentrically set.

15. The damping ratio signal processing method according to claim 10, wherein the displacement sensor is an LVDT displacement sensor, the bottom of the consolidation pressure device is connected to a top of the LVDT displacement sensor, and a bottom of the LVDT displacement sensor is connected to the top of the pressurized piston.

16. The damping ratio signal processing method according to claim 10, wherein the bracket includes a roof, a floor and a connecting rod, the connecting rod connects the roof and the floor in parallel, and the consolidation pressure device and the sleeve are set between the roof and the floor.

17. The damping ratio signal processing method according to claim 16, wherein a latex film is set between the connecting rod and the floor.

18. The damping ratio signal processing method according to claim 16, wherein the connecting rod is a screw connected with the roof by threads.
